(19) United States
(12) Patent Application Publication
(10) Pub. No.: US 2005/0242161 A1
(43) Pub. Date: Nov. 3, 2005

(54) Systems and methods for laser soldering flat flexible cable

(75) Inventor: Zhong-You Shi, Ann Arbor, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/836,877

(22) Filed: Apr. 30, 2004

(51) Int. Cl. B23K 31/00

(52) U.S. Cl. 228/180.21; 228/215

(57) ABSTRACT

A system and for interconnecting a flat flexible cable to an electronic circuit is disclosed. The system includes solder, a plurality of electronic components, and a solder resistant member. The solder is applied to a first and second plurality of solder pads of the electronic circuit. The plurality of electronic components are placed on the first plurality of solder pads of the electronic circuit having the applied solder. The solder resistant member is placed over the second plurality of solder pads of the electronic circuit having the applied solder. The electronic circuit, applied solder, plurality of electronic components and resistant solder member are heated until the solder reflows. The solder resistant member is removed after the solder has solidified. The flat flexible cable is attached to the second plurality of solder pads of the electronic circuit to form an electrical interconnection between the electronic circuit and the flat flexible cable.

### TECHNICAL FIELD

The present invention relates to systems and methods for soldering flat flexible cable to printed circuit boards such as FR4 board, flexible substrates and the like.

### BACKGROUND

Various methods for soldering electrical devices and other components to FR4 printed circuit board and flexible circuits have been developed through the years. One method includes the steps of applying solder paste to the various solder/conductor pads throughout the circuit board, populating the circuit board with electronic components and placing the board and components through a reflow oven where the circuit components and board are subjected to elevated temperatures to reflow the solder disposed between the electronic components and the solder pads on the board. However, not all the solder/conductor pads on the circuit board are populated with electronic components. For example, some solder/connector pads are typically configured to interconnect with takeouts or other flat flexible cables. These flat flexible takeouts or cables are not soldered at the same time as the other electronic components because they are susceptible to damage due to their material composition. Generally, these takeouts are electrically interconnected with the populated printed circuit board after the electronic components have been soldered to the circuit board. A laser or other heating element is used that may be localized and focused on the takeouts and takeout solder/conductor pads and not on the populated portions of the circuit board.

However, one significant problem found in prior art systems is that the pre-formed solder paste which is deposited on the takeout conductor or solder pads reflows during the soldering of the electronic components previously described. During that reflow process where the electronic components are soldered to their respective solder pads, the solder on the takeout solder pads reflows as well and upon cooling and solidifying, inconsistent solder bumps are formed. In other words, the solder bumps that are formed on the takeout conductor pads have irregular shapes and irregular heights and other dimensions. The problem with such irregularly shaped takeout solder bumps is that when the solder/conductor pads of a takeout cable are placed in contact with the irregular solder bumps to form an electrical interconnection, the conductor pads on the takeout cable may be insufficiently contacting the solder bumps on the circuit board preventing the reflow of the solder. Prior art systems and methods have addressed this problem by mechanically abrading away the irregularly shaped and sized solder bumps to obtain a flat surface across the solder bumps. While this method achieves its intended purpose, other problems still exist. For example, while some of the solder bumps may achieve a better contact with the takeout cable, others may have an insufficient contact area. Additionally, this abrading operation increases the cost of manufacturing.

Therefore, a new and improved system and method for interconnecting takeout cables with FR4 board, flexible circuit boards and similar devices is needed. The new and improved system and method should provide an even height and similar shape to the solder bumps disposed on conductor or solder pads of a printed circuit board.

### SUMMARY

In an aspect of the present invention a method for interconnecting a flat flexible cable to an electronic circuit is provided. The method includes applying solder to a first and second plurality of solder pads of the electronic circuit, placing a plurality of electronic components on the first plurality of solder pads of the electronic circuit having the applied solder, placing a nonstick solder member over the second plurality of solder pads of the electronic circuit having the applied solder, heating the electronic circuit, applied solder, plurality of electronic components and nonstick solder member until the solder reflows, removing the nonstick solder member after the solder has solidified, and attaching the flat flexible cable to the second plurality of solder pads of the electronic circuit to form an electrical interconnection between the electronic circuit and the flat flexible cable.

In another aspect of the present invention the method includes applying a pre-formed solder paste to the first and second plurality of solder pads.

In yet another aspect of the present invention the method includes applying a layer of flux over the applied solder.

In yet another aspect of the present invention the method includes transporting the electronic circuit through a reflow oven.

In yet another aspect of the present invention the method includes leveling the solder on the second plurality of solder pads of the electronic circuit.

In yet another aspect of the present invention the method includes placing each of the solder pads of the flat flexible cable in contact with the second plurality of solder pads of the electronic circuit.

In yet another aspect of the present invention the method includes fixing the flat flexible cable to the electronic circuit over the second plurality of solder pads and heating the solder dispose between solder pads on the flat flexible cable and the second plurality of solder pads on the electronic circuit.

In still another aspect of the present invention the method includes fixing the flat flexible cable to the second plurality of solder pads of the electronic circuit using a transparent plate.

In still another aspect of the present invention the method includes applying a laser beam to the transparent plate to heat and reflow the solder.

In still another aspect of the present invention a system for interconnecting a flat flexible cable to an electronic circuit is provided. The system includes solder, a plurality of electronic components, and a solder resistant member. The solder is applied to a first and second plurality of solder pads of the electronic circuit. The plurality of electronic components are placed on the first plurality of solder pads of the electronic circuit having the applied solder. The solder resistant member is placed over the second plurality of solder pads of the electronic circuit having the applied solder. The electronic circuit, applied solder, plurality of electronic components and resistant solder member are heated until the solder reflows. The solder resistant member is removed after the solder has solidified. The flat flexible cable is attached to the second plurality of solder pads of the electronic circuit to form an electrical interconnection between the electronic circuit and the flat flexible cable.

In still another aspect of the present invention the system includes a flux layer applied over the solder.

In still another aspect of the present invention the system includes a reflow oven for heating the electronic circuit, solder, plurality of electronic components and solder resistant member.

In still another aspect of the present invention the system includes a laser beam applied to the solder to heat and reflow the solder to attach the flat flexible cable to the second plurality of solder pads of the electronic circuit.

In still another aspect of the present invention the system includes a transparent plate for fixing the flat flexible cable to the electronic circuit while the laser operates to heat the solder disposed there between.

In still another aspect of the present invention the solder resistant member is an elongated flat plate that contacts the plurality of second solder pads of the electronic circuit.

In still another aspect of the present invention the elongated flat plate is made of a ceramic material that contacts the plurality of second solder pads of the electronic circuit.

In still another aspect of the present invention the elongated flat plate is made of titanium that contacts the plurality of second solder pads of the electronic circuit.

These and other aspects and advantages of the present invention will become apparent upon reading the following detailed description of the invention in combination with the accompanying drawings.

### BRIEF DESCRIPTION OF THE DRAWINGS

FIG. 1 is a plan view of an electronic circuit having a plurality of solder pads for interconnecting electronic components and the like to the circuit, in accordance with an embodiment of the present invention;

FIG. 2 is a cross-sectional view of a portion of the circuit of FIG. 1 illustrating a second plurality of solder pads, in accordance with an embodiment of the present invention;

FIG. 3 is a cross-sectional view of a portion of the circuit of FIG. 1 illustrating a second plurality of solder pads having solder disposed thereon, in accordance with an embodiment of the present invention;

FIG. 4 is a cross-sectional view of a portion of the circuit of FIG. 1 illustrating a second plurality of solder pads having solder disposed thereon and covered with a solder resistant plate, in accordance with an embodiment of the present invention;

FIG. 5 is a cross-sectional view of a portion of the circuit of FIG. 1 illustrating a second plurality of solder pads having solder disposed thereon after the solder resistant plate has been removed, in accordance with an embodiment of the present invention; and

FIG. 6 is a cross-sectional view of a portion of the circuit of FIG. 1 illustrating a second plurality of solder pads having solder disposed thereon and placed in contact with the solder pads disposed on a flat flexible cable, in accordance with an embodiment of the present invention.

### DESCRIPTION

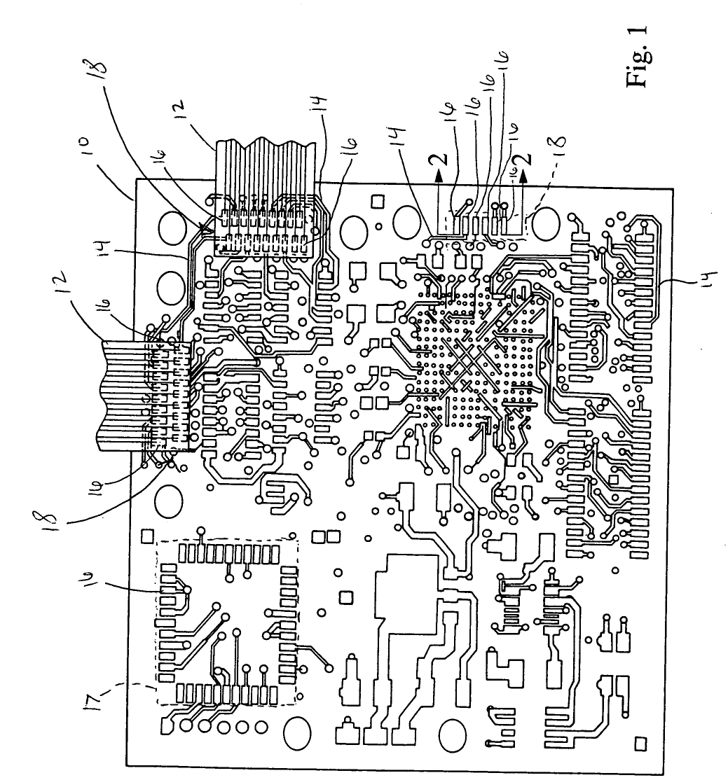

Referring now to FIG. 1 and electronic circuit board 10 is illustrated having cables 12 electrically interconnected thereto, in accordance with the present invention. Electronic circuit board 10 may be made of a rigid substrate such as an epoxy glass (i.e. FR4 board) or a flexible material such as polyester or the like. As well known in the industry circuit board 10 may be made of alternating conductive and insulating layers. The conductive layers include traces 14 and solder pads 16. The solder pads 16 typically interconnect with electronic devices 17 (shown in phantom) such as microprocessors, resisters, capacitors, transistors, and the like. Generally the interconnection is formed through a solder bond between electronic devices 17 and the solder pad 16. FIG. 1 is an illustration of an unpopulated circuit board. A populated circuit board would include all of the electronic devices 17 placed on their respective solder pads on circuit board 10.

Cables 12 as will be illustrated and described hereinafter include a plurality of conductor traces in communication with conductor pads which mate with cable attachment areas 18. Cable attachment areas 18 are defined by a plurality of conductor pads 16 that may be lined up in one or more rooms.

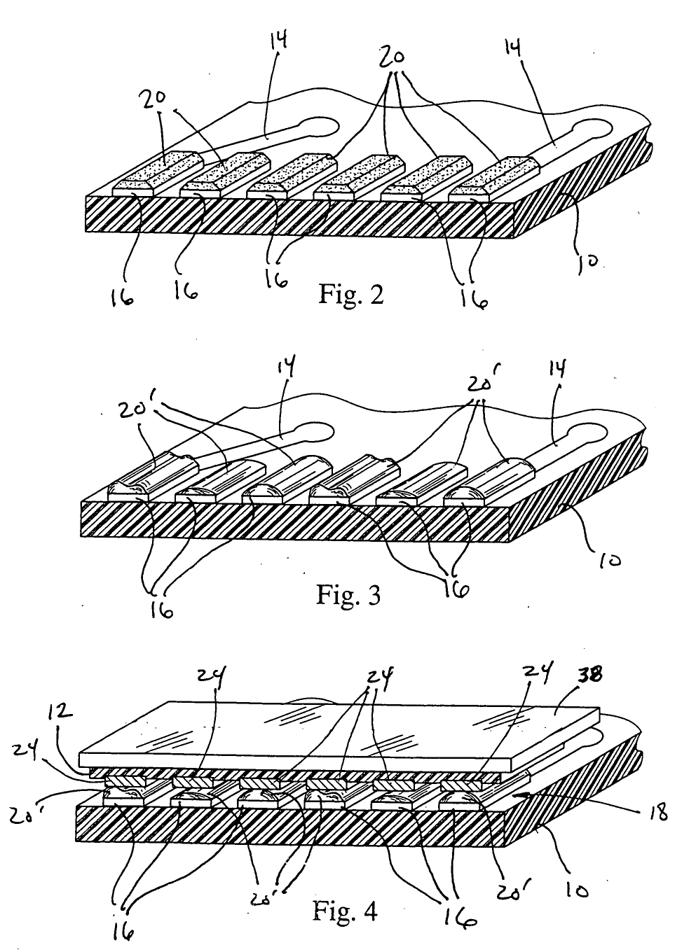

To appreciate the problems addressed by the present invention, conventional assembly methods for a manufacturing electronic circuit board 10 will now be described. In an initial step, the conductor pads or solder pads 16 on electronic circuit board 10 are covered with a solder paste or similar material. The solder paste may be stenciled onto the conductor pad 16 or applied using other known methods. Typically a flux layer is applied over the solder to promote bonding and flow of the solder to electronic devices 17. The electronic devices 17 are then placed over top of their respective conductor pads having the solder and flux layers. The now populated electronic circuit board 10 is placed in a reflow oven where the entire assembly is heated gradually to temperatures that cause the solder to reflow. However, it is well known that the cables 12 that are typically made of a flexible material formed of polyester, polypropylene or other plastic substrate may be damaged during the solder reflow process described above. In order to prevent damage to cables 12 it is well known to attach or interconnect cables 12 to their respective solder paths or connection areas 18 after electronic circuit board 10 has been subjected to the reflow process. In other words, cables 12 are soldered onto their respective connection areas by a localized soldering process after electronic circuit board 10 has been populated. In order to provide a better understanding of how cables 12 are soldered onto the connection area 18 a cross sectional view through the connection area 18 is illustrated in FIGS. 2 and 3. As previously described, in an initial step, solder pad 16 are covered with solder 20. The solder 20 is applied to solder pad 16 using various methods including stenciling. Typically the solder 20 is applied to solder pads 16 at the same time as solder is applied to all of the other solder pads on circuit board 10. Since cables 12, as previously mentioned, are not connected or placed on connection areas 18 during the reflow process the solder 20 on connection area 18 liquefies or reflows during the reflow process and changes its original shape, as shown for example, in FIG. 2 to non-uniform shapes or solder bumps 20′ shown in FIG. 3.

Problems arise when cable 12 is placed over solder bumps 20′ in an attempt to interconnect cable 12 with the connection area 18, as shown in FIG. 4. More specifically, several of these solder bumps 22 may have a larger height dimension age as compared to other solder bumps. This difference in heights between the several solder bumps 20′ prevents the conductor pads 24 of cable 12 from sufficiently contacting the solder on all of the conductor pads 16. Further, the area over which the conductor pads 24 contact the solder pads 22 is insufficient to transfer heat through cable 12 to reflow the solder, especially when a laser is used to heat cable 12.

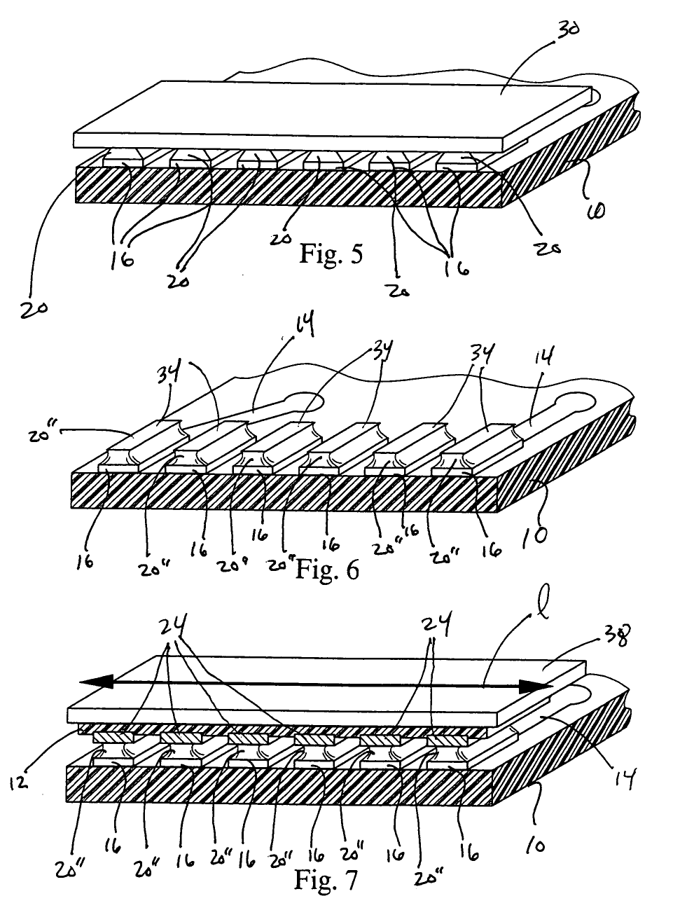

Referring now to FIG. 5 a method for preventing uneven, irregular sized solder bumps 20′ will now be described and illustrated, in accordance with the present invention. In an embodiment of the present invention, the formation of irregular solder bumps 20′ are prevented by the use of a non-stick or solder resistant member or plate 30. Plate 30 has sufficient area to extend over the entire connection are 18 and cover the solder 20 on conductor or solder pads 16. Non-stick plate 30 is applied or placed on the conductor pads 16 at the same time the other electronic devices 17 are placed on their respective solder pads. Non-stick plate 30 may be made of a titanium or other ceramic material that will not adhere to solder after the solder has liquefied of reflows. However, when the solder is liquefied during the reflow process, previously described, the non-stick member 30 forms a similarly shaped and sized solder bumps 20″ on pads 16. Moreover a flat surface 34 is formed in each of solder bumps 20″.

As shown in FIG. 6, when nonstick plate 30 has been removed, it can be seen that the solder bumps 20″ all have a flat surface 34 spaced equally above the solder pads 16. Now that solder bumps 20″ have similar shapes and height dimensions, flat flexible cable 12 may be interconnected to the solder area 18. Since the solder bumps 20″ are not irregularly shaped as in prior art methods, cable 12 having connector pads 24 make sufficient contact with solder bumps 20″ to allow heat to transfer through cable 12 and reflow the solder bumps 20″. Of course, the present invention contemplates any method for reflowing solder bumps 20″; however it is preferred to use a laser which may be controlled to provide heat locally in the vicinity of connection areas 18 only. The localized heating of the cable and connection area 18 prevents damage and reheating of the electronic devices 17 and their respective solder joints. The laser (and laser beam) is scanned over a transparent hold down plate 38, as indicated by arrow L. Hold down plate 38 allows the laser light to penetrate through to cable 12 and into conductors 24, solder bumps 20″ and conductor pads 16. In this manner, cable 12 is electrically interconnected to connect areas 18 on electronic circuit board 10.

As any person skilled in the art of systems and methods for soldering flat flexible cable to printed circuit boards such as FR4, flexible substrates and the like will recognize from the previous detailed description and from the figures and claims, modifications and changes can be made to the preferred embodiments of the invention without departing from the scope of this invention defined in the following claims.

1. A method for interconnecting a flat flexible cable to an electronic circuit, the method comprising:
applying solder to a first and second plurality of solder pads of the electronic circuit;
placing a plurality of electronic components on the first plurality of solder pads of the electronic circuit having the applied solder;
placing a nonstick solder member over the second plurality of solder pads of the electronic circuit having the applied solder;
heating the electronic circuit, applied solder, plurality of electronic components and nonstick solder member until the solder reflows;
removing the nonstick solder member after the solder has solidified; and
attaching the flat flexible cable to the second plurality of solder pads of the electronic circuit to form an electrical interconnection between the electronic circuit and the flat flexible cable.

2. The method of claim 1 wherein applying solder to the first and second plurality of solder pads further comprises applying a pre-formed solder paste to the first and second plurality of solder pads.

3. The method of claim 1 further comprising applying a layer of flux over the applied solder.

4. The method of claim 1 wherein heating the electronic circuit, applied solder, plurality of electronic components and nonstick solder member further comprising transporting the electronic circuit through a reflow oven.

5. The method of claim 1 wherein heating the electronic circuit, applied solder, plurality of electronic components and nonstick solder member further comprises leveling the solder on second plurality of solder pads of the electronic circuit.

6. The method of claim 1 wherein removing the nonstick solder member further comprises placing each of the solder pads of the flat flexible cable in contact with the second plurality of solder pads of the electronic circuit.

7. The method of claim 1 wherein attaching the flat flexible cable to the second plurality of solder pads of the electronic circuit further comprises fixing the flat flexible cable to the electronic circuit over the second plurality of solder pads and heating the solder dispose between solder pads on the flat flexible cable and the second plurality of solder pads on the electronic circuit.

8. The method of claim 1 wherein attaching the flat flexible cable to the second plurality of solder pads of the electronic circuit further comprises fixing the flat flexible cable to the second plurality of solder pads of the electronic circuit using a transparent plate.

9. The method of claim 8 wherein fixing the flat flexible cable to the second plurality of solder pads of the electronic circuit further comprises applying a laser beam to the transparent plate to heat and reflow the solder.

10. A system for interconnecting a flat flexible cable to an electronic circuit, the system comprising:
solder applied to a first and second plurality of solder pads of the electronic circuit;
a plurality of electronic components placed on the first plurality of solder pads of the electronic circuit having the applied solder; and
a solder resistant member placed over the second plurality of solder pads of the electronic circuit having the applied solder, and
wherein the electronic circuit, applied solder, plurality of electronic components and resistant solder member are heated until the solder reflows, and
wherein the solder resistant member is removed after the solder has solidified, and
wherein the flat flexible cable is attached to the second plurality of solder pads of the electronic circuit to form an electrical interconnection between the electronic circuit and the flat flexible cable.

11. The system of claim 10 wherein the solder is a pre-formed solder paste that is applied to the first and second plurality of solder pads.

12. The system of claim 10 further comprising a flux layer applied over the solder.

13. The system of claim 10 further comprising a reflow oven for heating the electronic circuit, solder, plurality of electronic components and solder resistant member.

14. The system of claim 10 further comprising a laser beam applied to the solder to heat and reflow the solder to attach the flat flexible cable to the second plurality of solder pads of the electronic circuit.

15. The system of claim 14 further comprising a transparent plate for fixing the flat flexible cable to the electronic circuit while the laser operates to heat the solder disposed there between.

16. The system of claim 10 wherein the solder resistant member is an elongated flat plate that contacts the plurality of second plurality of solder pads of the electronic circuit.

17. The system of claim 16 wherein the elongated flat plate is made of a ceramic material that contacts the plurality of second solder pads of the electronic circuit.

18. The system of claim 16 wherein the elongated flat plate is made of titanium that contacts the plurality of second solder pads of the electronic circuit.
